(19) United States
(12) Patent Application Publication
(10) Pub. No.: US 2009/0006379 A1
(43) Pub. Date: Jan. 1, 2009

(54) FILTERING METHOD AND SYSTEM FOR THE CORRELATION BETWEEN TESTING OBJECTS AND PATENTS

(76) Inventors: Geng-Shin Shen, Hsinchu City (TW); Hui-Chung Che, Taipei City (TW); Hou-Bai Lee, Taipei City (TW)

Correspondence Address: SINORICA, LLC, 528 FALLSGROVE DRIVE, ROCKVILLE, MD, 20850, US

(21) Appl. No.: 12/102,023

(22) Filed: Apr. 14, 2008

(30) Foreign Application Priority Data
Jun. 28, 2007 (CN) 200710112486.8

(51) Int. Cl. G06F 17/30

(52) U.S. Cl. 707/5; 707/E17.064

(57) ABSTRACT

In a filtering system for a correlation related to a composing element portfolio of a patent, a plurality of elements are defined by standard element codes and stored. Then composing elements of the patent are defined by the corresponding standard element codes in a standard element depository so as to form the composing element portfolio of the patent to be stored. Then an input module defines a composing element portfolio of the testing object according to the standard element codes. After that, the composing element portfolio input by the input module is matched with the composing element portfolio of each said patent. Afterward, matching result are sorted according to correlation and a sorted result based on the correlation is displayed.

### BACKGROUND OF THE INVENTION

1. Technical Field

The present invention relates to information matching methods, and more particularly, to a method for matching a composing element portfolio of a testing object with a composing element portfolio of a patent and a system corresponding to the method.

2. Description of Related Art

In the modern technique-intensive industries, enterprises or manufacturers aspire after filing patent applications for not only protecting their own RD achievements, but also stopping infringement against others suspected of infringing upon their patents relying on the exclusive right derived from their granted patents. Furthermore, some enterprises, such as Tessera Technologies Inc. in the US and Semiconductor Energy Laboratory (SEL) in Japan, who both have considerable sums of patents or patent applications, have even canceled their production lines for only remaining RD staff to proceed with the advanced development on their specialties so as to continuously increase the amount of their patent or patent applications. In such attempt, for identifying whether there is any colleague infringing their patent rights, the necessary analyses or infringement evaluation between the patents and suspected devices would be a labor-consuming work. The more the patents the enterprise possesses, the heavier the work is. Besides, in the technique-intensive industries, such as semiconductor process, semiconductor packaging or digital systems, there may be usually thousands to tens of thousand of related patents. Thus, when an enterprise intends to file a patent application for an invention, prior-art search and feature comparison are necessary for verifying the patentability of the invention, resulting in great inconvenience.

In view of the lack of an efficient method or device to solve the above problems encountered in practice, the present invention proposes a method and a system for matching a composing element portfolio of a testing object with a composing element portfolio of a patent a system corresponding to the method.

### SUMMARY OF THE INVENTION

For remedying the above problem, the primary objective of the present invention is to provide a method and a system, wherein a composing element portfolio of a testing object and a composing element portfolio of a patent are defined through a standard coding process and then defined codes of the composing element portfolio of the testing object are matched with defined codes of the composing element portfolio of the patent so as to enhance a matching efficiency between the testing object and the patent.

To achieve the above-mentioned objective, the present invention firstly provides a filtering system for a correlation between a testing object portfolio and a composing element portfolio of a patent. Therein, a plurality of elements are defined by standard element codes and stored. Then composing elements of the patent are defined by the corresponding standard element codes in a standard element depository so as to form a composing element portfolio of the patent to be stored. Then an input module also defines a composing element portfolio of the testing object according to the standard element codes. After that, the composing element portfolio input by the input module is matched with the composing element portfolio of each said patent. Afterward, matching results are sorted according to correlations and a sorted result based on the correlations is displayed.

The present invention also provides a filtering system for a correlation between a testing object portfolio and a composing element portfolio of a patent. Therein, a plurality of elements are defined by standard element codes and stored. Then composing elements of the patent are defined by the corresponding standard element codes in a standard element depository so as to form a composing element portfolio of the patent to be stored. Then an input module also defines a composing element portfolio of the testing object according to the standard element codes. After that, the composing element portfolio input by the input module is matched with the composing element portfolio of each said patent. Afterward, matching results are sorted according to correlations and a sorted result based on the correlations is displayed through a sifting module.

The present invention further provides a method for converting a testing object into codes, comprising: providing a standard element database that contains a plurality of standard elements; providing a testing object and identifying the standard elements contained in the testing object; defining the testing object according to identification codes defined in the standard element database so as to form a testing object code set that represents the testing object.

The present invention further provides a filtering method for a correlation between a testing object portfolio and a patent portfolio, comprising the following steps: providing a standard element database that contains a plurality of standard elements, wherein each of the standard elements has an identification code exclusively corresponding thereto; providing a first patent database that comprises a plurality of patents; analyzing on elements of each said patent successively so that the first patent database is composed of the elements contained in each said patent that is analyzed; further defining the elements contained in the first patent database according to the identification codes defined in the standard element database so to form a code set so that each said patent has its respective corresponding code set, whereby all of the patents in the first patent database are defined as their respective corresponding code sets by the standard element database and then converted into a second patent database; defining composing elements contained in the testing object according to the identification codes defined in the standard element database so as to form a testing object code set; providing a matching process to match the testing object code set with each said code set of the patents in the second patent database; forming a correlation database constructed from matching results sorted upon correlations, providing a ranking process to rank matching results in the correlation database according to the correlations to form a ranking database; and setting a programmable sifting criteria of the correlations so as to sort the correlations in the ranking database according to the sifting criteria and then output a sifting result.

### BRIEF DESCRIPTION OF THE DRAWINGS

The invention as well as a preferred mode of use, further objectives and advantages thereof, will best be understood by reference to the following detailed description of an illustrative embodiment when read in conjunction with the accompanying drawings, wherein:

FIG. 1 illustrates a coding example of the present invention;

FIG. 2 illustrates a flow chart of a filtering method a for a correlation between testing objects and patents of the present invention;

FIG. 3 illustrates another flow chart of the filtering method a for the correlation between testing objects and patents of the present invention, further comprising a ranking process;

FIG. 4 illustrates another flow chart of the filtering method a for the correlation between testing objects and patents of the present invention, further comprising a sifting process;

FIG. 5 illustrates an alternative embodiment of the filtering method for the correlation between testing objects and patents of the present invention;

FIG. 6 illustrates the alternative embodiment of the filtering method for the correlation between testing objects and patents of the present invention, which further comprises a ranking process;

FIG. 7 illustrates the alternative embodiment of the filtering method for the correlation between testing objects and patents of the present invention, which further comprises a sifting process;

FIG. 8 illustrates a method for converting a testing object into a code according to the present invention;

FIG. 9 illustrates yet another embodiment of the filtering method for the correlation between testing objects and patents of the present invention, which further comprises a sifting process; and

FIG. 10 illustrates a block diagram of the filtering system for the correlation between testing objects and patents of the present invention.

### DETAILED DESCRIPTION OF THE PREFERRED EMBODIMENT

While the present invention discloses a filtering method and a filtering system for correlations between testing objects and patents, the implemented technologies, such as databases and depositories used therein are well known in the art and need not be discussed at length herein. Furthermore, the accompany drawings attached herewith are for illustrating features in connection with the present invention only.

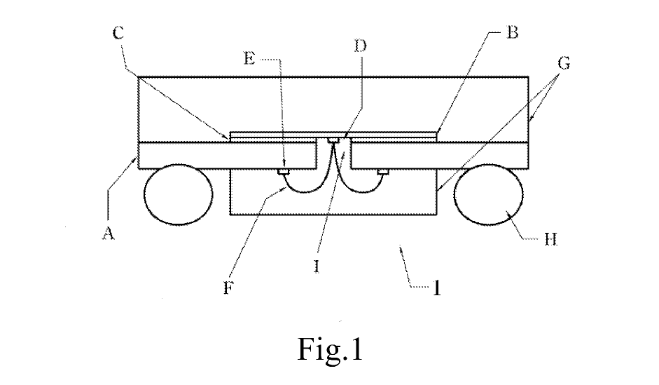

Before the preferred embodiments of the present invention, a technical exemplification is herein provided for illustration. Please refer to FIG. 1 for a diagram of a Ball Grid Array (BGA) package 1. The BGA package 1 comprises a substrate A, a chip B, an adhesive layer C, a metal terminal D on the chip, a bonding pad E on the chip, a bonding wire F, a molding compound G, a solder ball H and an opening I formed at a center of the substrate A. Meanwhile, for expressing different embodiments, such as the substrates with and without the central opening, the substrates may be further suffixed for representing different embodiments, such as Aₓ, wherein x is an integer (x=1, 2, 3 . . . ), so that the substrates with the central opening may be coded as A₁ while the substrates without the central opening may be coded as A₂, and so on. Besides, the chip may be coded in the same manner. For example, a flip chip may be coded as B₁, and a non-flip chip may be coded as B₂. However, in practical embodiments, for fitting the configuration of the substrate, the metal terminal D₁ may be settled at the center of the chip for corresponding to the substrate A₁ having the central opening. Alternatively, the metal terminal D₂ may be settled at a peripheral region of the chip for fitting the substrate A₂. Furthermore, the adhesive layer C may be a thermosetting adhesive material C₁. The alternative adhesive layer C may be assigned with a code according to its material or adhesive means. The rest elements for constructing the BGA are coded in the same manner so that each of the standard elements has one and only standard element code. Then the standard element codes are stored in a standard element database 100. Hence, data stored in the standard element database 100 are in the forms of the standard element codes.

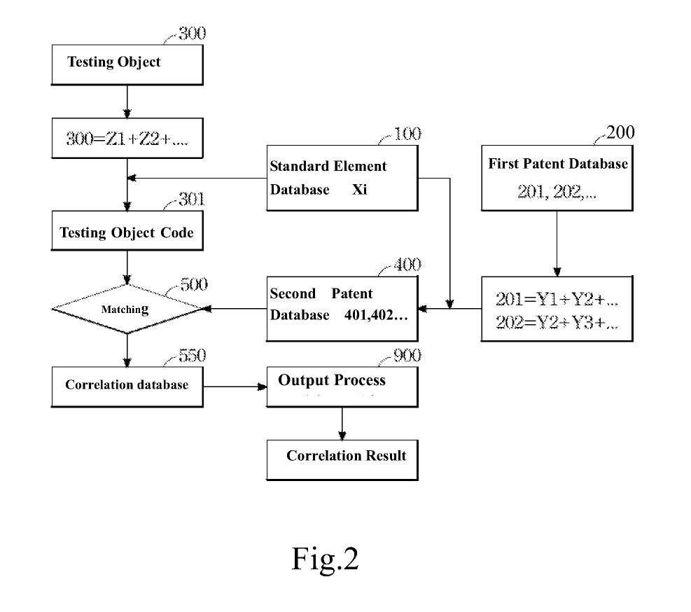

Now referring to FIG. 2 for a flow chart of the filtering method for the correlation between testing objects and patents of the present invention, steps in the flow chart will be explained successively as below. As shown in FIG. 2, first, the standard element database 100, which comprises a plurality of codes of the standard elements, is formed, wherein the standard elements are coded in the aforementioned process so that each of the standard elements has an identification code Xi exclusively corresponding thereto, in which X=A, B, C, D and i is an integer. Then a first patent database 200 is established. The first patent database 200 may contain a plurality of patents possessed by a certain company or may contain a plurality of patents related to a certain technology. When the first patent database 200 is well established, a claim construction for claims of each of the patents in the first patent database 200 is conducted. Namely, elements of each said patent 201 are analyzed. Therefore, the first patent database 200 is actually composed of elements Yi contained in each said analyzed patent 201. For example, one said patent 201=A₁+B₂+C₁, wherein the patent 201 is embodied as a BGA package in the form of the non-flip chip B₂ having the substrate A₁ with the central opening, and the thermosetting adhesive material C₁ for combining the chip and the substrate. Afterward, the elements contained in the first patent database 200 are further defined according to the identification codes Xi defined in the standard element database 100, so as to form a code set 401, so that each said patent 201 has its respective corresponding code set 401. Thereby, all of the patents 201 in the first patent database 200 are defined through the standard element database 100 into the respective corresponding code sets 401 that are then converted into a second patent database 400.

Then, a testing object 300 is provided, which may be a suspected infringement device having a substantiality, a photo of a suspected infringement device, a diagram of a suspected infringement device, a design chart or a patent specification, according to practical needs. The testing object 300 may also be one or a combination of the recited items in the above group. Following, elements Zi contained in the testing object 300 are to be identified, wherein Zi is composed in a coding process similar to that for coding Yi. Then the elements Zi of the testing object 300 is defined according to the identification codes Xi defined in the standard element database 100, so as to form a testing object set 301.

After the code set 401 of each of the patents 201 in the first patent database 200 and the testing object set 301 are established, since each said code set 401 and the testing object set 301 are both defined according to the identification codes Xi of the standard element database 100, when there is an identical element existing in the both, this identical element has the identical identification code Xi, and therefore a comparison is possible. Then, a matching process 500, where the testing object set 301 is matched with the code sets 401 in the second patent database 400, is provided. A matching result of the matching process 500 is stored in a correlation database 550 constructed according to the different correlations 501. Therein, when there are relatively more identical identification codes Xi between the code set 401 in the second patent database 400 and the testing object set 301, the code set 401 and the testing object set 301 are verified as having the relatively higher correlation therebetween. When there are relatively less identical identification codes Xi between the code set 401 in the second patent database 400 and the testing object set 301, the code set 401 and the testing object set 301 are verified as having the relatively lower correlation therebetween. After that, an output process 900 may be provided for outputting the correlation database 550. Hence, an engineering director or a patent engineer in an enterprise can use the matching result of the correlation between the testing object 300 and the patent portfolio 200 to proceed with a following infringement analysis or design around.

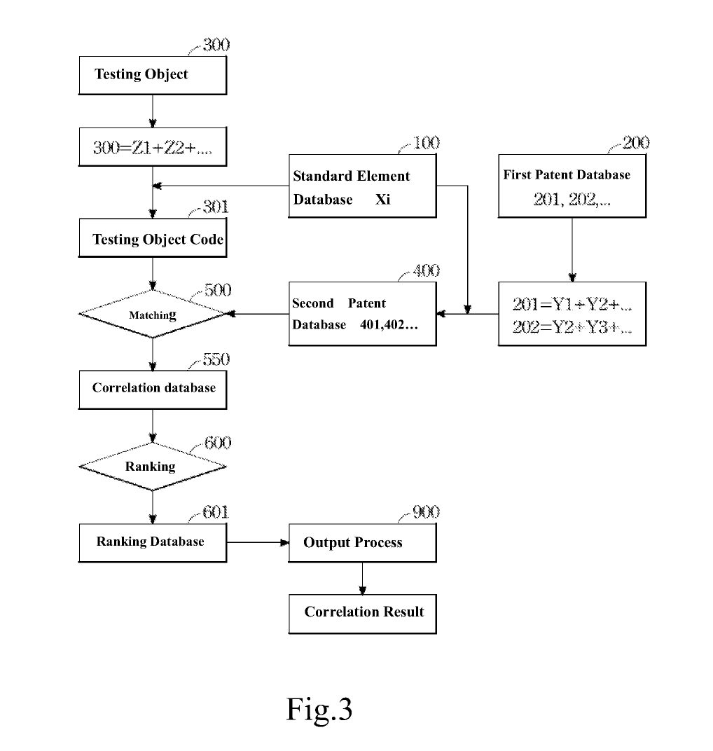

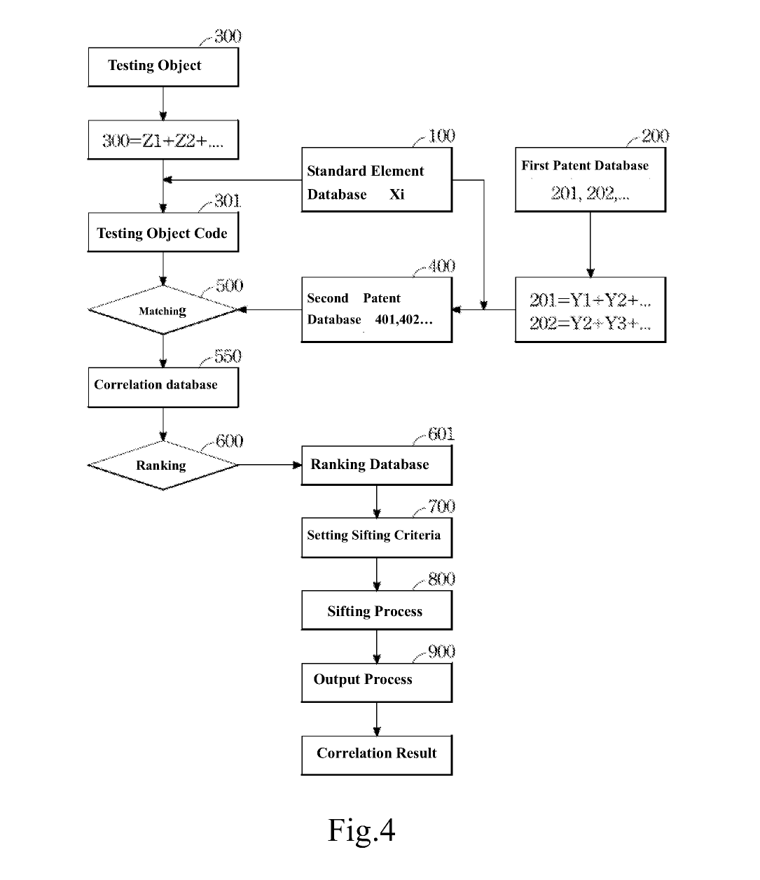

In the above embodiment, a ranking process 600 may be further provided, as shown in FIG. 3, for sorting the correlations 501 in the correlation database 550. While it is possible to rank the correlations 501 from the higher correlation to the lower correlation, it is also possible to rank them in a contrary order. After the ranking process 600 associated to the correlations 501 in the correlation database 550, a ranking database 601 is formed. Additionally, in the present embodiment, some sifting criteria 700 built upon specific said correlations 501 may be set so that the ranking database 601 can output a sifting result, as shown in FIG. 4. In the present embodiment, for example, the sifting criteria 700 are set as having at least three identical elements. Thus, through the effective setting of the sifting criteria 700, a sifting process 800 for comparing the sifting criteria 700 with the correlations 501 in the correlation database 550, can process the correlations 501 stored in the ranking database 601 so that only the patents satisfying the sifting criteria 700 are output, thereby further reducing the number of the patents to be identified or evaluated. At last, in the present embodiment, an output process 900 may be provided for outputting a result satisfying the sifting criteria 700. Thus, through the above steps, a sifting result based on a specific level related to the correlations 501 between the testing object 300 and the patent portfolio 200 can be derived.

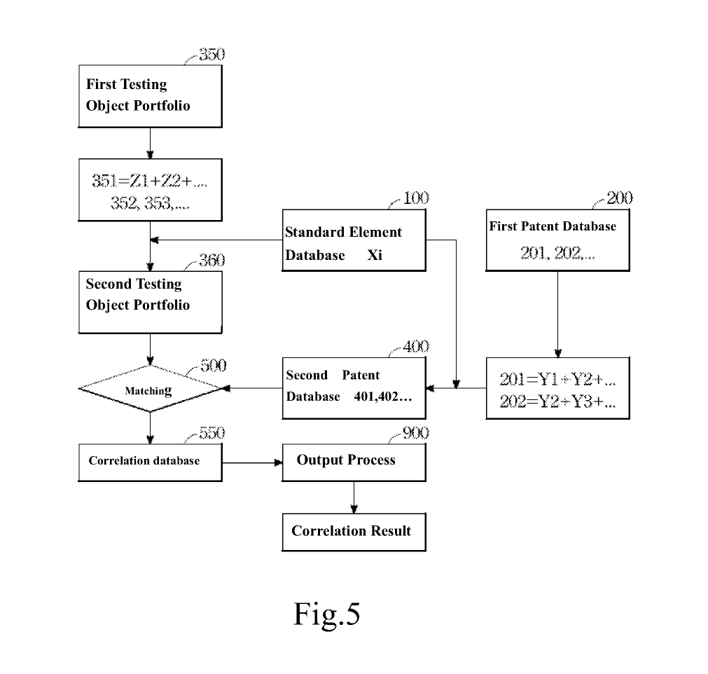

An alternative embodiment of the present invention, as shown in FIG. 5, is different from its counterpart in the former embodiment by the testing object that is substantially a combination of a plurality of patents instead of the single testing object of the former embodiment. Referring to FIG. 5, in the present embodiment, a standard element database 100, which comprises a plurality of codes of the standard elements, is formed, wherein the standard elements are coded in the aforementioned process so that each of the standard elements has an identification code Xi exclusively corresponding thereto, in which X=A, B, C, D and i is an integer. Then a first patent database 200 is established. The first patent database 200 may contain a plurality of patents possessed by a certain enterprise or may contain a plurality of patents related to a certain technology. When the first patent database 200 is well established, a claim construction for claims of each of the patents in the first patent database 200 is conducted. Namely, elements of each said patent 201 are analyzed. Therefore, the first patent database 200 is actually composed of elements Yi contained in each said analyzed patent 201. Afterward, the elements contained in the first patent database 200 are further defined according to the identification codes Xi defined in the standard element database 100, so as to form a code set 401, so that each said patent 201 has its respective corresponding code set 401. Thereby, all of the patents 201 in the first patent database 200 are defined through the standard element database 100 into the respective corresponding code sets 401 that are then converted into a second patent database 400.

Then, a first testing object portfolio 350 is provided, which contains a plurality of testing objects (351, 352, . . . ). Following, elements Zi contained in each said testing object 351 are to be identified, and defined according to the identification codes Xi defined in the standard element database 100, so as to form a testing object code set 361. The testing objects (351, 352, . . . ) of the first testing object combination 350 defined according to the identification codes Xi form a second testing object portfolio 360, which is constructed from the converted testing object code sets (361,362,363 . . . ). Similarly, these testing objects (351, 352, . . . ) may be a group of patents where design around is to be done according to practical needs. Therefore, each said testing object may be a suspected infringement device having a substantiality, a photo of a suspected infringement device, a diagram of a suspected infringement device, a design chart or a patent specification, while the testing object portfolio 350 or 360 may be one or a combination of the recited items in the above group.

After the code sets 401 and the testing object code sets 361 are established, since each said code set 401 and the testing object code set 361 are both defined according to the identification codes Xi of the standard element database 100, when there is an identical element existing in the both, this identical element has the identical identification code Xi, and therefore a comparison is possible.

Then, a matching process 500, where the testing object code set 361 in the second testing object portfolio 360 is matched with each said code set 401 in the second patent database 400, is provided. A matching result of the matching process 500 is stored in a correlation database 550 constructed according to the different correlations 501. Therein, when there are relatively more identical identification codes Xi between the code set 401 in the second patent database 400 and the testing object code set 361, the code set 401 and the testing object code set 361 are verified as having the relatively higher correlation therebetween. When there are relatively less identical identification codes Xi between the code set 401 in the second patent database 400 and the testing object code set 361, the code set 401 and the testing object code set 361 are verified as having the relatively lower correlation therebetween. After that, an output process 900 may be provided for outputting the correlation database 550. Hence, an engineering director or a patent engineer in an enterprise can use the matching result of the correlation between the testing object portfolio 350 and the patent portfolio 200 to proceed with a following infringement analysis or design around.

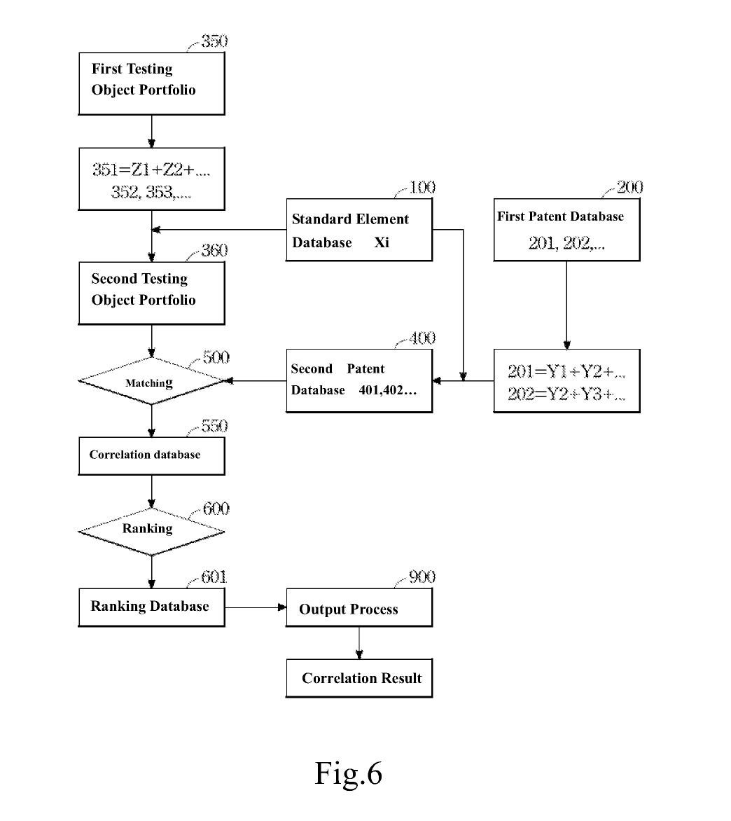

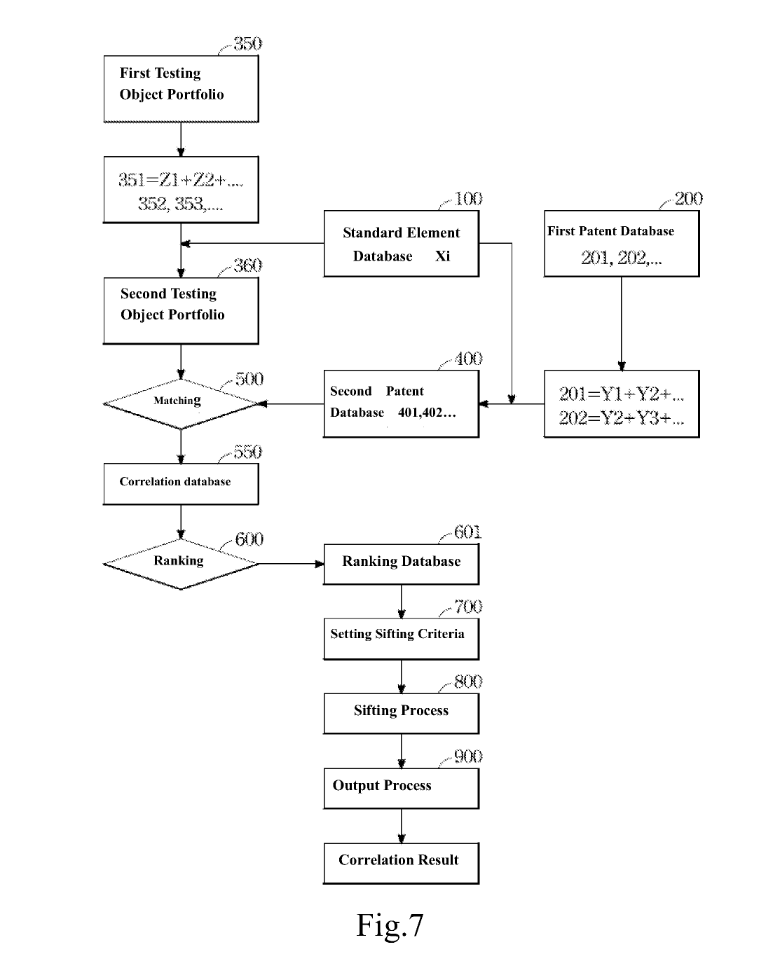

In the above embodiment, a ranking process 600 may be further provided, as shown in FIG. 6, for sorting the correlations 501 in the correlation database 550. While it is possible to rank the correlations 501 from the higher correlation to the lower correlation, it is also possible to rank them in a contrary order. After the ranking process 600 associated to the correlations 501 in the correlation database 550, a ranking database 601 is formed. Additionally, in the present embodiment, some sifting criteria 700 built upon specific said correlations 501 may be set so that the ranking database 601 can output a sifting result, as shown in FIG. 7. For example, the sifting criteria 700 are set as having at least three identical elements. Thus, through the effective setting of the sifting criteria 700, a sifting process 800 for comparing the sifting criteria 700 with the correlations 501 in the correlation database 550, can process the correlations 501 stored in the ranking database 601 so that only the patents satisfying the sifting criteria 700 are output, thereby further reducing the number of the patents to be identified or evaluated. At last, in the present embodiment, an output process 900 may be provided for outputting a result of the sifting process 800. At last, in the present embodiment, an output process 900 may be provided for outputting a result satisfying the sifting criteria 700. Thus, through the above steps, a sifting result based on a specific correlation 501 between the testing object 300 and the patent portfolio 200 can be derived.

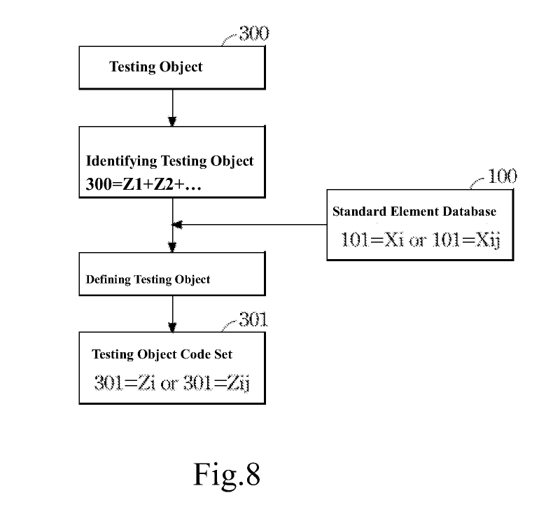

For further expressing the technical features in detail, in the above embodiments, the coding process may employ a 2-stage coding manner. Taking FIG. 1 for example, the substrates A may be further suffixed for representing the substrates with or without the central opening, such as Aᵢⱼ, wherein i and j are both integers (1,2,3 . . . ), so that the substrates with the central opening may be coded as A₁ⱼ while the substrates without the central opening may be coded as A₂ⱼ. The substrates of another configurations may be also coded with proper expression of “i” and “j”. Besides, the chip may be coded in the same manner. For example, a flip chip may be coded as B₁ⱼ, and a non-flip chip may be coded as B₂ⱼ. In the present embodiment, the metal terminal D₁ on the chip may be omitted and incorporated into the description of the chip. The rest elements for constructing the BGA are coded in the same manner so that each of the standard elements has one and only standard element code. Then the standard element codes are stored in a standard element database 100. Accordingly, FIG. 8 illustrates a method for converting a testing object 300 into a code according to the present invention. Therein, a standard element database 100, which contains a plurality of standard elements and each said standard element has an exclusive corresponding identification code Xᵢ or Xᵢⱼ, is firstly provided. Then a testing object 300 is provided, wherein the testing object 300 may be a patent or a combination of a plurality of patents. After that, standard elements Zᵢ contained in the testing object 300 are identified, and each said testing object 300 is defined according to the identification codes Xᵢ or Xᵢⱼ defined in the standard element database 100. At last, a testing object code set 301 representing the testing object 300 is formed. It is obvious that the testing object code set 301 of the testing object 300 may be defined as the one-stage code or two-stage code, Zᵢ or Zᵢⱼ, according to the one-stage or two-stage identification code Xᵢ or Xᵢⱼ defined in the standard element database 100.

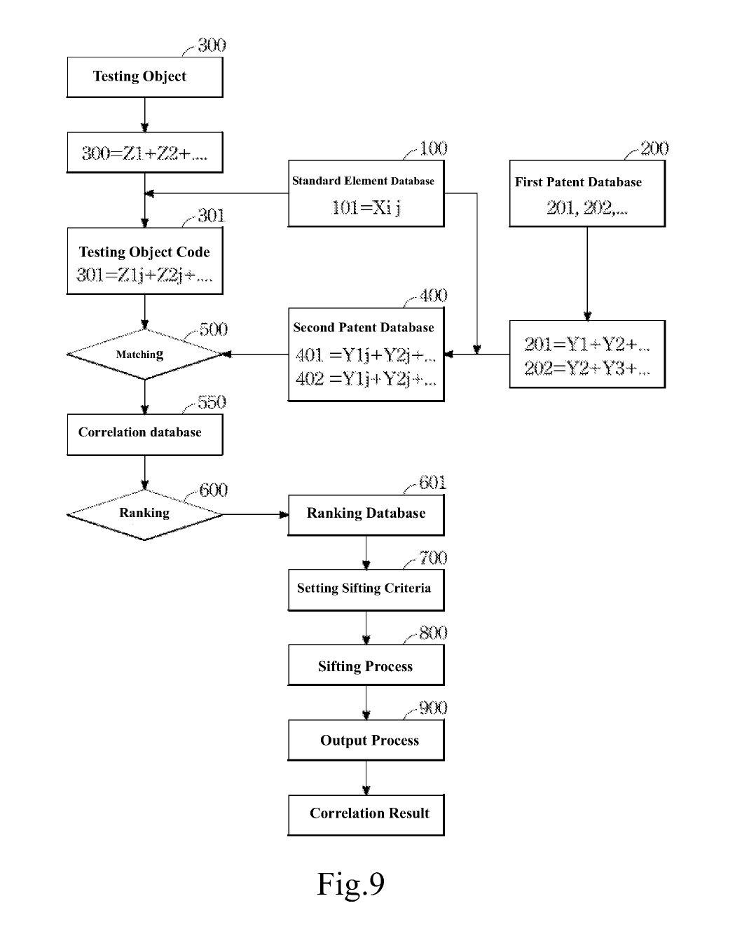

In FIG. 9, the identification code of each standard element 101 in the standard element database 100 is converted into the form of Xᵢⱼ, wherein X=A, B, C, D . . . while i and j are integers. Meantime, the elements contained in each said patent 201 in the first patent database 200 may be converted into the form of Yᵢⱼ of the second patent database 401 according to the identification codes Xᵢⱼ. The elements contained in the testing object 300 can be converted into the form of Zᵢⱼ in the testing object set 301 through the identification codes Xᵢⱼ. Thus, during the matching process, when there is an identical element existing in the both, the identical element has the identical identification code and therefore the testing object set 301 Zᵢⱼ and the second patent database 401 Yᵢⱼ can be compared. Afterward, a ranking process 600 may be further added ranking the correlations 501 in the correlation database 550. While it is possible to rank the correlations 501 from the higher correlation to the lower correlation, it is also possible to rank them in a contrary order. After the ranking process 600 associated to the correlations 501 in the correlation database 550, a ranking database 601 is formed. Additionally, in the present embodiment, some sifting criteria 700 built upon specific said correlations 501 may be set so that the ranking database 601 can output a sifting result. For example, the sifting criteria 700 are set as having at least three identical elements and having the substrate A₁ⱼ with the central opening. Thus, through the effective setting of the sifting criteria 700, only the patents satisfying the sifting criteria 700 are output, thereby further reducing the number of the patents to be identified or evaluated. At last, in the present embodiment, an output process 900 may be provided for outputting a result satisfying the sifting criteria 700. Thus, through the above steps, a sifting result based on a specific level related to the correlations 501 between the testing object 300 (or the testing object portfolio 350) and the patent portfolio 200 can be derived.

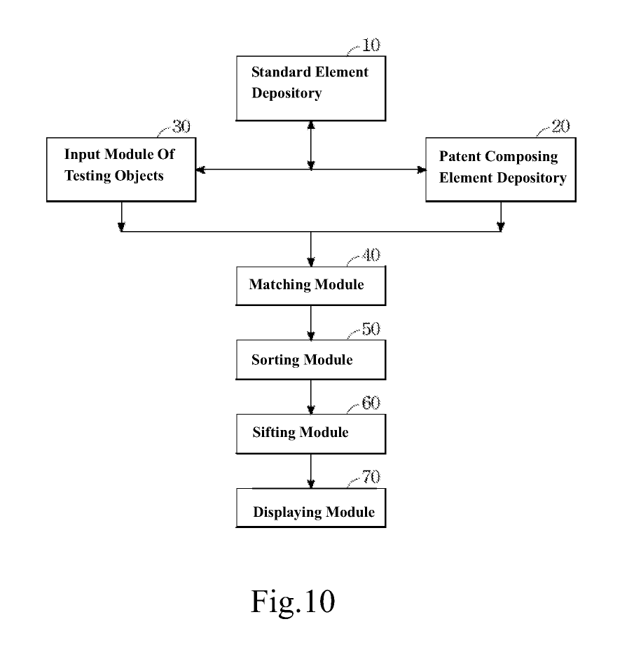

The present invention further discloses a filtering system for the correlation between testing objects and patents, as shown in FIG. 10. In the disclosed filtering system, a standard element depository 10 defines and stores a plurality of standard elements 101 by identification codes Xᵢ or Xᵢⱼ. Then in a plurality of patents each having a plurality of preset composing elements, each said composing element of each patent is define according to the code Xᵢ or Xᵢⱼ of the corresponding standard element stored in the standard element depository 10. Then composing elements of a plurality of patents are stored in a patent composing element depository 20 in a form of a portfolio. After that, composing elements of a testing object are defined according to the code Xᵢ or Xᵢⱼ in the standard element depository 10 so that an input module of testing objects 30 inputs the defined composing elements of the testing object into a matching module 40; At this time, since the composing elements of the testing object and those of the patent are coded by the same coding process, an element portfolio of the testing object input from the input module of testing objects 30 can be matched with an element portfolio of each said patent defined in the patent composing element depository 20. Then, a sorting module 50 receives a matching result form the matching module 40 and sort the matching result according to correlations. When the portfolios from the patent composing element depository 20 and the input module of testing objects 30 are compared, if there are relatively more identical identification codes therebetween, the both are verified as having the relatively higher correlation therebetween. On the contrary, if there are relatively less identical identification codes therebetween, the both are verified as having the relatively lower correlation therebetween. At last, a displaying module 70 displays a sorting result related to the correlations generated by the sorting module 50. Similarly, the disclosed filtering system may further comprise a sifting module 60, for inputting a preset correlation value into the sorting module 50 so as to produce the sorting result determined by the correlations.

The preferred embodiment of the present invention have been provided above are for illustration but not limitation to the present invention. For example, the coding method may be realized by a 3-stage coding method, such as Aᵢⱼₖ. Moreover, the matching process may be a sequential matching or a parallel matching. It will be understood by one of ordinary skill in the art that numerous variations will be possible to the disclosed embodiments without going outside the scope of the invention as disclosed in the claim.

What is claimed is:

1. A filtering method for a correlation between a testing object and a patent portfolio, primarily comprising steps of:
providing a standard element database, which contains comprising a plurality of standard elements, wherein each of the standard elements has an identification code (X) exclusively corresponding thereto;
providing a first patent database, which contains a plurality of patents; analyzing elements of each said patent successively to identify elements (Y) contained in the patent, then further defining the elements (Y) according to the identification codes (X) defined in the standard element database to form a code set, whereby all of the patents in the first patent database are defined according to the respective corresponding code set and stored as a second patent database;
providing the testing object, identifying elements (Z) contained in the testing object, and defining the elements (Z) of the testing object according to the identification codes (X) defined in the standard element database so as to form a testing object code set;
providing a matching process, which matches the testing object code set with the code set of the patents in the second patent database, so that a matching result form a correlation database constructed from the correlation, wherein, when there are relatively more identical identification codes (X) between the code set in the second patent database and the testing object code set, the code set and the testing object code set are defined as having the relatively higher correlation therebetween, while when there are relatively less identical identification codes (X) between the code set in the second patent database and the testing object code set, the code set and the testing object code set are defined as having the relatively lower correlation therebetween;
providing a ranking process, which ranks data in the correlation database according to a level order of the correlation so as to form a ranking database;
setting a specific said correlation as sifting criteria;
providing a sifting process, which categorizes the correlation in the ranking database according to the sifting criteria; and
providing an output process to output a filtered result of the sifting process;
whereby, the sifting result based on a specific level related to the correlation between the testing object and the patent portfolio is derived.

2. The filtering method of claim 1, wherein, the identification code (X) in the standard element database is a one-stage code (Xᵢ), a two-stage code (Xᵢⱼ), a three-stage code (Xijk) or a code with more stages.

3. The filtering method of claim 1, wherein, the testing object is one or a combination of an article having a substantiality, a photo of an article having a substantiality, a diagram of an article, a design chart and a patent specification.

4. The filtering method of claim 1, wherein, the matching process comprises a sequential matching process or a parallel matching process.

5. A filtering method for a correlation between a testing object and a patent portfolio, primarily comprising steps of:
providing a standard element database, which contains comprising a plurality of standard elements, wherein each of the standard elements has an identification code (X) exclusively corresponding thereto;
providing a first patent database, which contains a plurality of patents; analyzing elements of each said patent successively to identify elements (Y) contained in the patent, then further defining the elements (Y) according to the identification codes (X) defined in the standard element database to form a code set, whereby all of the patents in the first patent database are defined according to the respective corresponding code set and stored as a second patent database;
providing the testing object, identifying elements (Z) contained in the testing object, and defining the elements (Z) of the testing object according to the identification codes (X) defined in the standard element database so as to form a testing object code set;
providing a matching process, which matches the testing object code set with the code set of the patents in the second patent database, so that a matching result form a correlation database constructed from the correlation, wherein, when there are relatively more identical identification codes (X) between the code set in the second patent database and the testing object code set, the code set and the testing object code set are defined as having the relatively higher correlation therebetween, while when there are relatively less identical identification codes (X) between the code set in the second patent database and the testing object code set, the code set and the testing object code set are defined as having the relatively lower correlation therebetween;
providing a ranking process, which ranks data in the correlation database according to a level order of the correlation so as to form a ranking database; and
providing an output process to output the ranking database;
whereby, the sifting result based on a specific level related to the correlation between the testing object and the patent portfolio is derived.

6. The filtering method of claim 5, wherein, the identification code (X) in the standard element database is a one-stage code (Xᵢ), a two-stage code (Xᵢⱼ), a three-stage code (Xijk) or a code with more stages.

7. The filtering method of claim 5, wherein, the testing object is one or a combination of an article having a substantiality, a photo of an article having a substantiality, a diagram of an article, a design chart and a patent specification.

8. The filtering method of claim 5, wherein, the matching process comprises a sequential matching process or a parallel matching process.

9. A filtering method for a correlation between a testing object portfolio and a patent portfolio, primarily comprising steps of:
providing a standard element database, which contains comprising a plurality of standard elements, wherein each of the standard elements has an identification code (X) exclusively corresponding thereto;
providing a first patent database, which contains a plurality of patents; analyzing elements of each said patent successively to identify elements (Y) contained in the patent, then further defining the elements (Y) according to the identification codes (X) defined in the standard element database to form a code set, whereby all of the patents in the first patent database are defined according to the respective corresponding code set and stored as a second patent database;
providing a first testing object portfolio, which comprises a plurality of testing objects, successively identifying elements (Z) contained in each said testing object, and defining the elements (Z) of the testing object according to the identification codes (X) defined in the standard element database so as to form a testing object code set and defining each said testing object in the first testing object portfolio according to the identification codes (X) to form a second testing object portfolio;
providing a matching process, which matches the second testing object portfolio with the code set of the patents in the second patent database, so that a matching result form a correlation database constructed from the correlation, wherein, when there are relatively more identical identification codes (X) between the code set in the second patent database and the testing object code set, the code set and the testing object code set are defined as having the relatively higher correlation therebetween, while when there are relatively less identical identification codes (X) between the code set in the second patent database and the testing object code set, the code set and the testing object code set are defined as having the relatively lower correlation therebetween;
providing a ranking process, which ranks data in the correlation database according to a level order of the correlation so as to form a ranking database;
setting a specific said correlation as sifting criteria;
providing a sifting process, which categorizes the correlation in the ranking database according to the sifting criteria; and
providing an output process to output a sifting result of the sifting process;
whereby, the sifting result based on a specific level related to the correlation between the testing object portfolio and the patent portfolio is derived.

10. The filtering method of claim 9, wherein, the identification code (X) in the standard element database is a one-stage code (Xᵢ), a two-stage code (Xᵢⱼ), a three-stage code (Xijk) or a code with more stages.

11. The filtering method of claim 9, wherein, the testing object is one or a combination of an article having a substantiality, a photo of an article having a substantiality, a diagram of an article, a design chart and a patent specification.

12. The filtering method of claim 9, wherein, the matching process comprises a sequential matching process or a parallel matching process.

13. A method for converting the testing object into a code, primarily comprising steps of:
providing a standard element database, which contains comprising a plurality of standard elements, wherein each of the standard elements has an identification code (X) exclusively corresponding thereto;
providing the testing object;
identifying standard elements (Z) contained in the testing object;
defining the testing object according to the identification codes (X) defined in the standard element database; and
forming a testing object code set that represents the testing object.

14. The filtering method of claim 13, wherein, the identification code (X) in the standard element database is a one-stage code (Xᵢ), a two-stage code (Xᵢⱼ), a three-stage code (Xijk) or a code with more stages.

15. The filtering method of claim 13, wherein, the testing object is one or a combination of an article having a substantiality, a photo of an article having a substantiality, a diagram of an article, a design chart and a patent specification.

16. A filtering system for a correlation between a testing object portfolio and a composing element portfolio of a patent, comprising:
a standard element depository, defining and storing a plurality of standard elements by codes;
a depository containing a plurality of previously defined elements, wherein the previously defined elements define composing elements of the patent according to the code of the corresponding standard element in the standard element depository and storing the composing elements in a form of a portfolio;
an input module of testing object composing element portfolio, which defining testing object composing elements according to the codes of the standard elements;
a matching module, which matches a testing object composing element portfolio inputted by the input module of testing object composing element portfolio with the composing element portfolio of each said patent in the depository containing the plural previously defined elements;
a sorting module, which sorts a matching result of the matching process according to a level order of the correlation so as to form a ranking database; and
a displaying module, which displays a sorting result of the correlation;
wherein, when there are relatively more identical identification codes between the composing element portfolio of the patent and the composing element portfolio of the testing object inputted by the input module of testing object composing element portfolio, the composing element portfolios are defined as having the relatively higher correlation therebetween, while when there are relatively less identical identification codes between the composing element portfolios, the composing element portfolios are defined as having the relatively lower correlation therebetween.

17. The filtering method of claim 16, wherein, the identification code (X) in the standard element database is a one-stage code (Xᵢ), a two-stage code (Xᵢⱼ), a three-stage code (Xijk) or a code with more stages.

18. The filtering method of claim 16, wherein, the testing object is one or a combination of an article having a substantiality, a photo of an article having a substantiality, a diagram of an article, a design chart and a patent specification.

19. The filtering method of claim 16, wherein, the matching process comprises a sequential matching process or a parallel matching process.

20. A filtering system for a correlation between a testing object portfolio and a composing element portfolio of a patent, comprising:
a standard element depository, defining and storing a plurality of standard elements by codes;
a depository containing a plurality of previously defined elements, wherein the previously defined elements define a patent composing element according to the code of the corresponding standard element in the standard element depository and storing the patent composing element in a form of a portfolio;
an input module of testing object composing element portfolio, which defining testing object composing elements according to the codes of the standard elements;
a matching module, which matches a testing object composing element portfolio inputted by the input module of testing object composing element portfolio with the composing element portfolio of each said patent in the depository containing the plural previously defined elements;
a sorting module, which sorts matching result of the matching module according to a level order of the correlation;
a sifting module, which inputs a preset correlation value into the sorting module so as to output a sorting result after the correlation value is determined;
a displaying module, which displays the sorting result of the correlation;
wherein, when there are relatively more identical identification codes between the composing element portfolio of the patent and the composing element portfolio of the testing object inputted by the input module of testing object composing element portfolio, the composing element portfolios are defined as having the relatively higher correlation therebetween, while when there are relatively less identical identification codes between the composing element portfolios, the composing element portfolios are defined as having the relatively lower correlation therebetween.

21. The filtering system of claim 20, wherein, the identification code (X) in the standard element database is a one-stage code (Xᵢ), a two-stage code (Xᵢⱼ), a three-stage code (Xijk) or a code with more stages.

22. The filtering system of claim 20, wherein, the testing object is one or a combination of an article having a substantiality, a photo of an article having a substantiality, a diagram of an article, a design chart and a patent specification.

23. The filtering system of claim 20, wherein the matching module comprises a sequential matching module or a parallel matching module.
